(19) United States
(12) Patent Application Publication
(10) Pub. No.: US 2004/0109679 A1
(43) Pub. Date: Jun. 10, 2004

(54) Method and apparatus for writing data by calculating addresses, and digital camera utilizing the same

(75) Inventors: Tsuyoshi Watanabe, Gifu-shi (JP); Shigeyuki Okada, Ogaki-shi (JP)

Correspondence Address: McDERMOTT, WILL & EMERY, 600 13th Street, N.W., Washington, DC, 20005-3096, US

(73) Assignee: Sanyo Electric Co., Ltd.

(21) Appl. No.: 10/725,285

(22) Filed: Dec. 2, 2003

(30) Foreign Application Priority Data
Dec. 3, 2002 (JP) JP2002-351302

(51) Int. Cl. H04N 5/76; H04N 5/225

(52) U.S. Cl. 386/112; 386/117

(57) ABSTRACT

When the coding processings are performed in parallel, coded data need to be so arranged that the coded data are properly stored in a memory, thus preventing a storage operation from being executed at high speed. A group of encoders encode image data, respectively, and notifies an address specifying unit of the amount of code data. The code data generated by the group of encoders are temporarily stored in a group of temporary buffers. A code buffer write unit reads out the code data from the group of temporary buffers. Then, the code buffer write unit writes, in parallel, to the memory the code data corresponding to a plurality of data blocks, starting from write-start positions calculated by the address specifying unit.

### BACKGROUND OF THE INVENTION

1. Field of the Invention

The present invention relates to data write technologies and digital cameras, and it particularly relates to method and apparatus for writing data to memories and a digital camera utilizing them.

2. Description of the Related Art

When the image data are recorded on the recording medium or transmitted via a network, the data are oftentimes compressed prior to recording and transmitting them. For example, in JPEG (Joint Photographic Expert Group) image coding system which is recently being used widely as the standard compression method, the data are divided into blocks and each of the blocks is subject to the DCT (Discrete Cosine Transform), the quantization and the Huffman coding as variable length coding, so that the images are compressed in the highly efficient manner. The JPEG and other image compression techniques are nowadays employed in the various consumer products, and are indispensable for small devices, digital cameras in particular, where the hardware resource areas are limited. However, the highly-efficiency technologies generally involve the relatively large computational load and thus need to be devised drastically to achieve the reduction in the processing time. For this reason, there are provided two coding circuits according to the patent specification of the following Related Art List (1), so that the attempt was made to reduce the processing time through the parallel processing by these two coding circuits.

2. Related Art List

(1) Japanese Patent Application Laid-Open No. Hei5-227519, FIGS. 1 and 2.

In the Related Art List (1), the coded data outputted from the two coding circuits are once stored in the code memories which are temporary buffers. Then, data are read out sequentially from these coding memories and outputted externally from the code outputting circuit. In this structure, however, while the data are being read out from one of the code memories, the other code memories are put to a stand-by state. When the code memory is put to the standby state, the data to be subsequently written to said code memory is also put on hold. As a result thereof, caused are timings at which the operation of the coding circuit must be put on hold. Although increasing the capacity of the code memories makes it possible to store both the data put on hold to be read out and the data outputted from the code circuit, it of course accompanies the increase in the cost of the code memories as well as the increase in the circuit area therefor.

### SUMMARY OF THE INVENTION

The present invention has been made in view of the foregoing circumstances, and an object thereof is to provide a data write technology to realize a high-speed processing with the minimum cost increase and to provide digital cameras utilizing this data write technology.

A preferred embodiment according to the present invention relates to a method of writing data. This method includes: specifying the size of processed data deriving from each data block when a predetermined processing is performed in parallel on a plurality of data blocks; and specifying a write-start address for the plurality of data blocks by calculating addresses based on the size specified by the specifying the size, wherein the write-start address is used when the processed data deriving from each data block is written to a memory. The “predetermined processing” may be an arbitrary processing and may be different for each of the plurality of data blocks. The “data block” may be of arbitrary size, and is not directly related to a macroblock or block defined in JPEG.

This method further includes writing, in parallel, to the memory the processed data deriving from the plurality of data blocks, according to the write-start addresses specified for the plurality of data blocks. This writing may realize a state where the processed data deriving from the plurality of data blocks are stored in the memory in a continuous manner at the time when this writing has been completed.

Another preferred embodiment according to the present invention relates to a data writing apparatus. This apparatus includes: an address specifying unit which calculates an address based on the size of processed data deriving from each data block when a predetermined processing is performed on a plurality of data blocks in parallel, and which specifies a write-start address used when the processed data deriving from each data block are written to a memory, for the plurality of data blocks; and a write control unit which writes, in parallel, to the memory the processed data deriving from the plurality of data blocks, according to the write-start addresses specified for the plurality of data blocks.

Still another preferred embodiment according to the present invention relates to a coding apparatus. This apparatus includes: a plurality of encoders which perform, in parallel, variable-length coding on a plurality of data blocks; and an address specifying unit which specifies, based on the amount of coded data generated by the encoders, a write-start address which is used when the coded data are written to a memory, for the plurality of data blocks; and a write control unit which writes, in parallel, to the memory the processed data deriving from the plurality of data blocks, according to the write-start addresses specified for the plurality of data blocks.

Still another preferred embodiment according to the present invention relates to a digital camera. This camera includes: an image pickup unit; a mechanism control unit which controls mechanism of the image pickup unit; and a processing unit which processes digital images obtained by the image pickup unit, wherein the processing unit performs coding, in parallel, on a plurality of data blocks that constitute the digital images, and when coded data generated by the coding are written, in parallel, to a memory, the processing unit realizes a state where the coded data deriving from the plurality of data blocks are stored in the memory in a continuous manner at the time when writing the coded data has been completed.

For example, the processing unit includes: a plurality of encoders which perform, in parallel, variable-length coding on a plurality of data blocks that constitute an digital image; an address specifying unit which specifies, based on the coded data generated by the coding, a write-start address used when the coded data are written to a memory, for the plurality of data blocks; and a write control unit which writes, in parallel, to the memory the coded data deriving from the plurality of data blocks, according to the write-start addresses specified for the plurality of data blocks.

It is to be noted that any arbitrary combination of the above-described structural components and expressions changed between a method, an apparatus, a system, a recording medium, a computer program and so forth are all effective as and encompassed by the present embodiments.

Moreover, this summary of the invention does not necessarily describe all necessary features so that the invention may also be sub-combination of these described features.

### BRIEF DESCRIPTION OF THE DRAWINGS

FIG. 1 is a block diagram showing a structure of a coding apparatus according to an embodiment of the present invention.

FIG. 2 shows a structure of a first encoder in the coding apparatus shown in FIG. 1.

FIG. 3 is a timing chart showing a coding operation by the coding apparatus shown in FIG. 1.

FIG. 4 is a block diagram showing a structure of a digital camera according to another embodiment of the present invention.

### DETAILED DESCRIPTION OF THE INVENTION

The invention will now be described based on the following embodiments which do not intend to limit the scope of the present invention but exemplify the invention. All of the features and the combinations thereof described in the embodiments are not necessarily essential to the invention.

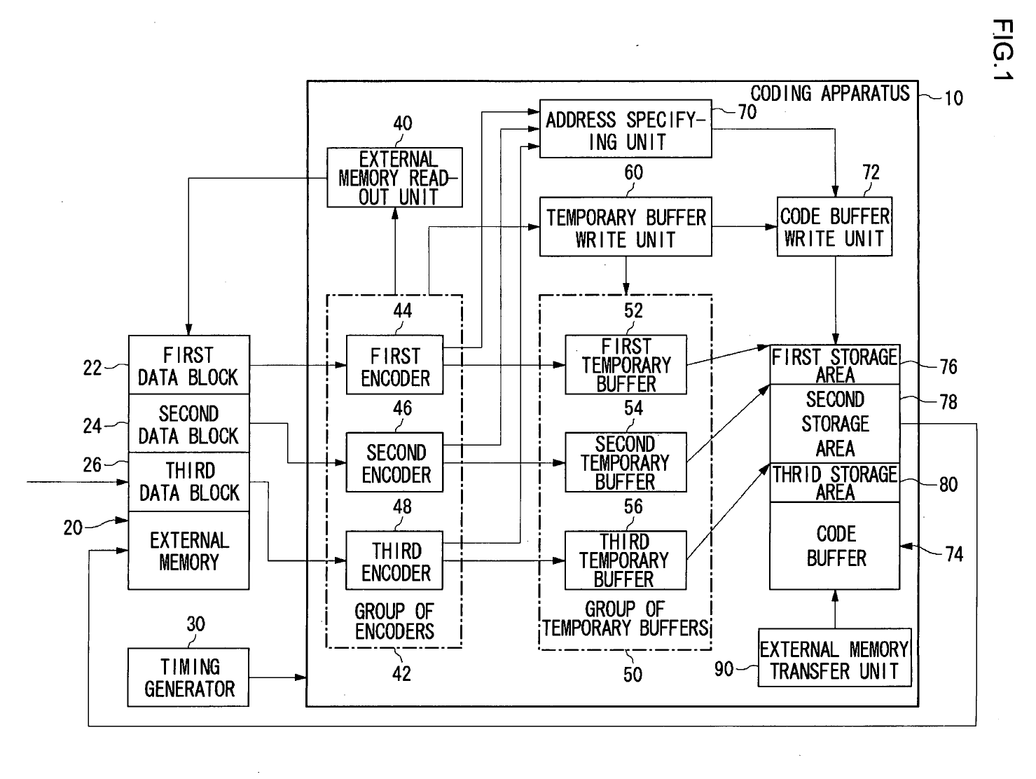

FIG. 1 shows a structure of a coding apparatus 10 according to an embodiment of the present invention. In terms of hardware, this structure can be realized by a CPU of an arbitrary personal computer, a memory or other LSIs. In terms of software, the structure is realized by programs having a memory-loaded coding and data write function or the like. But drawn in FIG. 1 and described here are function blocks that are realized in cooperation with those. Thus, it is understood by those skilled in the art that these function blocks can be realized in a variety of forms by hardware only, software only or the combination thereof. It is shown here as an example that the coding apparatus is incorporated into an LSI.

Referring to FIG. 1, image data are loaded from an external memory 20 by the coding apparatus 10, and a coding processing is performed thereon at timing generated by a timing generator 30. The results of the coding processing are written back to the external memory 20. Original image data prior to being compressed are inputted to the memory 20 from an image pickup device, a network, a recording medium, which are all not shown here, or the like. The thus inputted image data are stored in a manner such that a storage area is divided into a first data block 22, a second data block 24, a third data block 26 and the like and the data are partitioned as appropriate and stored in each of the data blocks. These data blocks may be of arbitrary sizes, and appropriate sizes thereof may be determined in terms of a relationship with the coding apparatus 10; the size may be determined by, for example, an experiment and the like. The sizes of these data blocks may be set in a system register (not shown) by a CPU, so as to allow variable sizes. The external memory 20 is structured by a memory, having a relatively large capacity, such as an SDRAM (Synchronous Dynamic Random Access Memory). The timing generator 30 generates various clocks and supplies them to the coding apparatus 10.

The coding apparatus 10 includes an external memory readout unit 40 which, as appropriate, reads out data from the external memory 20, a group of encoders 42 which code the read-out data 20, a group of temporary buffers 50 which temporarily store the coded data, a temporary buffer write unit 60 which controls the write of the data to the group of temporary buffers 50, an address specifying unit 70 which acquires information on the amount of coded data from the group of encoders 42 and computes a write-start address (described later), a code buffer write unit 72 which reads out the data from the group of temporary buffers 50 and performs a write processing, in parallel, on the coded data according to the write-start address notified from the address specifying unit 70, a code buffer 74 to which the coded data are written, and an external memory transfer unit 90 which writes the coded data arranged within the code buffer 74 back into the external memory 20.

The group of encoders 42 includes a plurality of encoders. According to the present embodiment, a first encoder 44, a second encoder 46 and a third encoder 48 constitute the group of encoders 42. However, the number of encoders included therein may be arbitrary. “Coding” performed by the group of encoders 42 is meant in the broad sense, and thus the coding here performs the above-mentioned DCT, quantization and Huffman coding. The first encoder 44, second encoder 46 and third encoder 48 encode, in parallel, the image data stored in the first data block 22, second data block 24 and third data block, respectively. The timing at which data to be coded is requested is conveyed to the external memory readout unit 40. The external memory readout unit 40 sequentially supplies necessary data from the respective data blocks to the respective encoders.

The group of temporary buffers 50 includes a first temporary buffer 52, a second temporary buffer 54 and a third temporary buffer 56. The first to third temporary buffers 52 to 56 store temporarily the coded data outputted from the first to third encoders 44 to 48, respectively. Each of the temporary buffers has the enough capacity to store the coded data outputted from each of the respective encoders. The timing at which the coded data are outputted is notified from the group of encoders 42 to the temporary buffer write unit 60, so that the temporary buffer write unit 60 writes the coded data to each of the temporary buffers at said timing.

The address specifying unit 70 inputs the amount of coded data, from the first encoder 44, second encoder 46 and third encoders 48 so as to calculate the write-start addresses. Here, the amount of coded data implies the total number of code bits. Now, suppose that the amount of coded data in the first encoder 44, second encoder 46 and third encoder 48 are L₁, L₂ and L₃, respectively. Suppose also that the write-start addresses used to write the coded data from the three encoders 44 to 48 to the code buffer 74 are A₁, A₂ and A₃, respectively. Then, the address specifying unit 70 calculates A₁, A₂ and A₃ from L₁, L₂ and L₃, based on the following procedure.

A₁=0

A₂=L₁

A₃=L₁+L₂

The write-start addresses calculated thus are notified to the code buffer write unit 72.

The code buffer write unit 72 reads out the coded data from the first temporary buffer 52, second temporary buffer 54 and third temporary buffer 56, respectively. And the code buffer write unit 72 sequentially writes the read-out coded data, in parallel, to the first storage area 76, second storage area 78 and third storage area 80 starting from the top position thereof, respectively. Here, the top positions of the first storage area 76, second storage area 78 and third storage area 80 correspond to the above-described write-start positions A₁, A₂ and A₃. As a result, the coded data which have been read out from the first temporary buffer 52, second temporary buffer 54 and third temporary buffer 56 are stored, in their exact amounts, in the first storage area 76, second storage area 78 and third storage area, respectively. Thus, there no unused free area is caused, and the necessary data are protected against being overwritten due to the area shortage.

The coded data arranged thus in the code buffer 74 are sequentially read out from the external memory transfer unit 90 and then are stored in a free space of the external memory 20.

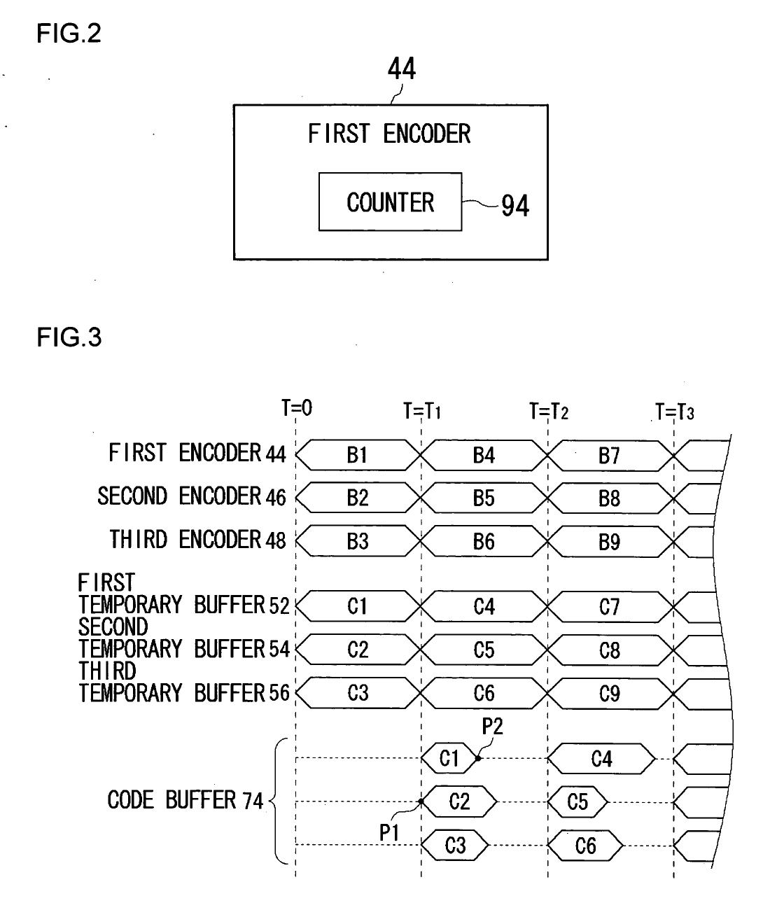

FIG. 2 shows an internal structure of the first encoder 44 in the coding apparatus 10. The first encoder 44 includes a counter 94 which counts the size of coded data generated by the first encoder 44. The counter 94 counts up the data in units of byte, word or bit until the first encoder 44 completes coding the data of the first data block 22. The counter 94 then notifies the address specifying unit 70 of the total size of coded data, namely, the amount of coded data. The structures of the second encoder 46 and the third encoder 48 are similar to that of the first encoder 44.

Next, operations of the above structures will be described hereinbelow. First, image data to be coded are inputted to the group of encoders 42 from the external memory 20. The first encoder 44, second encoder 46 and third encoder 48 perform the coding on the image data stored in the divided manner in the respective first data block 22, second data block 24 and third data block 26. The amount of the code data generated by the respective data blocks are notified to the address specifying unit 70. The coded data are inputted to the group of temporary buffers 50, and are respectively stored temporarily in the first temporary buffer 52, second temporary buffer 54 and third temporary buffer 56. The address specifying unit 70 calculates the write-start addresses and notifies the code buffer write unit 72 of the calculated write-start addresses. The code buffer write unit 72 writes the coded data read out from the respective first temporary buffer 52, second temporary buffer 54 and third temporary buffer 56 in a manner such that the addresses A₁, A₂ and A₃ of the code buffer 74 are set to the respective top positions and the coded data are written, in parallel, to the first storage area 76, second storage area 78 and third storage area 80. The external memory transfer unit 90 reads out, as appropriate, coded data from the code buffer 74 and stores them in the free space of the external memory 20.

FIG. 3 is a timing chart explaining the above-described operations. Referring to FIG. 3, Bn corresponds to the number of the data block which is divided within the external memory 20. For example, B1 indicates the first data block 22. B4, though not shown in FIG. 1, exists next to the third data block 26. The same applies to B5, B6 and so forth. Cn shows coded data deriving from each data block. For example, C1 is data which is coded by the first encoder 44 after having been read out from the first data block 22.

Still referring to FIG. 3, a series of processings starts at time T=0, and the coding of B1, B2 and B3 are simultaneously started at the first encoders 44, second encoders 46 and third encoders 48, respectively. As the coding proceeds, the coded data C1, C2 and C3 appear in sequence and these coded data are stored in the first temporary buffer 52, second temporary buffer 54 and third temporary buffer 56, respectively. The processings performed on B1, B2 and B3 are terminated at time T=T1. At this time, the amounts of coded data which have been determined by the first encoders 44, second encoders 46 and third encoders 48, respectively, are sent to the address specifying unit 70, so that the code buffer write unit 72 can specify the write-start positions. Thus, the writing of the coded data C1, C2 and C3 to the code buffer 74 is started at T=T1. The writing of these coded data to the code buffer 74 terminates at different timings in FIG. 3. This is because the amount of codes differs as a result of variable-length coding in the group of encoders 42. It is to be noted here that the same advantageous effects can be obtained even if the time for the coding may differ among the respective encoders. For the sake of brevity, the description in the present embodiments herein assumes that time for the coding is the same for each encoder.

The writing of the data from the group of temporary buffers 50 to the code buffer 74 starts at T=T1, so that free spaces are caused at T=T1 in the respective first temporary buffer 52, second temporary buffer 54 and third temporary buffer 56. Consequently, the group of encoders 42 can start the coding for the next data blocks, namely, B4, B5 and B6. From T=T1 on, the data C4, C5 and C6 which are coded and outputted from the data blocks are stored in the first temporary buffer 52, second temporary buffer 54 and third temporary buffer, respectively. When the coding terminates at T=T2, the amounts of coded data are decided. Thus, starts the writing of the coded data by the code buffer write unit 72 to the code buffer 74. The same processing is repeated thereafter.

According to the above embodiment, not only the coding processings are carried out in parallel but also the writing of coded data to the code buffer 74 is carried out in parallel, so that the overall coding processing is done at significantly high speed. Besides, the write-start positions are calculated by the address specifying unit 70, so that the write-start address of coded data deriving from each data block can be specified appropriately even when the variable-length coding is done. Thus, situations can be avoided where there exists a gap or space in the coded data in the code buffer 74 and where some coded data are left out and not stored because the coded data exceeds the capacity of the code buffer 74.

If the address calculation by the address specifying unit 70 is absent, a write-start timing P1 at which the writing of the coded data C2, deriving from the second data block, to the code buffer 74 is started must wait for an end timing P2 at which the writing of the coded data C1, deriving from the first data block, to the code buffer 74 is terminated. Hence, the writing of coded data to the code buffer 74 is delayed. Furthermore, a free space is not created in the second temporary buffer 54, so that the processing by the second encoder 46 must be put on hold. Thus, the effect otherwise achieved by the group of encoders 42 configured in parallel would be somewhat lost. Accordingly, the address calculation by the address specifying unit 70 is indispensable for the present embodiment.

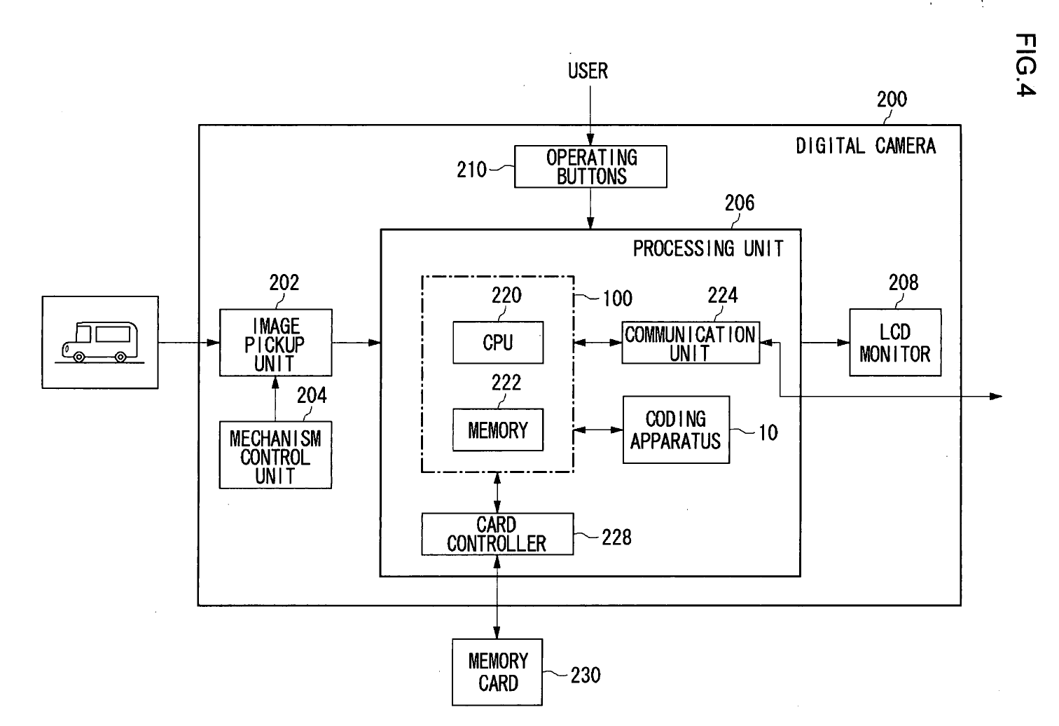

FIG. 4 shows a structure of a digital camera 200 according to another embodiment. The digital camera 200 includes an image pickup unit 220, a mechanism control unit 204, a processing unit 206, an LCD monitor 208 and operating buttons 210.

The image pickup unit 202 includes a lens, a diaphragm, a CCD, a signal processing unit and so forth, all of which are not shown here. The electric charges accumulate according to the quantity of light of an object which is image-formed on a light receiving surface, and the accumulated electric charges are read out as voltage signals. The voltage signal is decomposed into R, G and B components, and then white-balance-adjusted and gamma-corrected. Then, the R, G and B signals are A-D converted and the thus converted digital image data are outputted to the processing unit 206. The mechanism control unit 204 controls the image pickup unit 202, namely, it controls the driving mechanism of zooming, focusing, aperture and so forth.

The processing unit 206 includes a main control unit 100 comprised of a CPU 220 and a memory 222 for controlling the whole of the digital camera 200, a card controller 228, a communication unit 224 and a coding apparatus 10 of FIG. 1. The first data block 22 shown in FIG. 1 may be realized by utilizing part of this memory 222 or may be the memory of a memory card 230. This digital camera further includes an image decoding apparatus (not shown) which decodes the coded data.

The communication unit 224 performs a control such as a protocol conversion according to the standard communication specifications. Besides, the communication unit 224 exchanges data via respective interfaces with external equipment such as a printer and a game machine. The LCD monitor 208 not only functions as a finder but also displays a shoot/reproduction mode, a zoom factor, date and time and so forth as well as the captured images. When the images are shot by a user, they are once stored in the external memory 20 shown in FIG. 1 and then are coded at high speed by the coding apparatus 10 and compressed as coded data so as to be finally stored in the external memory 20. According to the digital camera 200, the compression and storage are performed very fast when capturing the images. Thus, the increase in the cost is suppressed to the minimum and the performance of the digital camera is improved realizing high-speed continuous shooting and high-speed image transfer.

The present invention has been described based on the embodiments which are only exemplary. It is understood by those skilled in the art that there exist other various modifications to the combination of each component and process described above and that such modifications are encompassed by the scope of the present invention. Such modified examples will be described hereinbelow.

In the present embodiments, the coding is used as a processing but any other arbitrary processing may be used. This is because the present embodiments operate on resulting data from the coding or other processings and thus do not depend on any particular contents of a processing. However, if the processing is such that the amount of coded data obtained after the processing are of variable type, the present embodiments will be further effective. In such a processing, the write-start addresses need to be specified when the data are written, in parallel, to the memory 20, so that the address specifying unit 70 functions as an effective means.

The coding apparatus 10 shown in FIG. 1 has a high degree of freedom in the structure thereof. For example, the first data block 22 may be included in the coding apparatus 10, and the timing generator 30 may also be included in the coding apparatus 10. Conversely, the code buffer 74 may be provided externally to the coding apparatus 10, and the external memory transfer unit 90 may also be provided externally to the coding apparatus 10. Any structural degree of freedom is permitted essentially as long as the write-start addresses are specified by the address specifying unit 70 and the high-speed writing that utilizes the thus specified write-start address is realized.

In the present embodiments, the coding apparatus 10 is incorporated into an LSI. However, the structure is not limited thereto. For example, the address specifying unit 70 may be realized by software, and the same may apply to the group of encoders 42.

A “write control unit” in WHAT IS CLAIMED may be exemplified as the code buffer write unit 72 in the present embodiments. Similarly, a “memory” in WHAT IS CLAIMED may be exemplified as the code buffer 74 in the present embodiments.

Although the present invention has been described by way of exemplary embodiments, it should be understood that many changes and substitutions may further be made by those skilled in the art without departing from the scope of the present invention which is defined by the appended claims.

What is claimed is:

1. A method of writing data, including:
specifying the size of processed data deriving from each data block when a predetermined processing is performed, in parallel, on a plurality of data blocks; and
specifying a write-start address for the plurality of data blocks by calculating addresses based on the size specified by said specifying the size, wherein the write-start address is used when the processed data deriving from each data block is written to a memory.

2. A method according to claim 1, wherein the predetermined processing is coding.

3. A method according to claim 2, wherein the coding is variable-length coding.

4. A method according to claim 1, wherein said specifying a write-start address is such that the processed data deriving from the plurality of data blocks are stored in the memory in a continuous manner at the time when writing the processed data has been completed.

5. A data writing apparatus, including:
an address specifying unit which calculates an address based on the size of processed data deriving from each data block when a predetermined processing is performed on a plurality of data blocks in parallel, and which specifies a write-start address used when the processed data deriving from each data block are written to a memory, for the plurality of data blocks; and
a write control unit which writes, in parallel, to the memory the processed data deriving from the plurality of data blocks, according to the write-start addresses specified for the plurality of data blocks.

6. A data writing apparatus according to claim 5, wherein the predetermined processing is coding.

7. A data writing apparatus according to claim 6, wherein the coding is variable-length coding.

8. A data writing apparatus according to claim 6, wherein said address specifying unit calculates the amount of coded data deriving from each data block.

9. A data writing apparatus according to claim 5, wherein said write control unit realizes a state in which the processed data deriving from the plurality of data blocks are stored in the memory in a continuous manner at the time when writing the processed data has been completed.

10. A coding apparatus, including:
a plurality of encoders which perform, in parallel, variable-length coding on a plurality of data blocks; and
an address specifying unit which specifies, based on the amount of coded data generated by said encoders, a write-start address which is used when the coded data are written to a memory, for the plurality of data blocks; and
a write control unit which writes, in parallel, to the memory the processed data deriving from the plurality of data blocks, according to the write-start addresses specified for the plurality of data blocks.

11. A coding apparatus according to claim 10, wherein said address specifying unit calculates the amount of coded data deriving from each data block.

12. A coding apparatus according to claim 10, wherein said write control unit realizes a state in which the processed data deriving from the plurality of data blocks are stored in the memory in a continuous manner at the time when writing the processed data has been completed.

13. A digital camera, including:
an image pickup unit;
a mechanism control unit which controls mechanism of said image pickup unit; and
a processing unit which processes digital images obtained by said image pickup unit,
wherein said processing unit performs coding, in parallel, on a plurality of data blocks that constitute the digital images, and when coded data generated by the coding are written, in parallel, to a memory, said processing unit realizes a state in which the coded data deriving from the plurality of data blocks are stored in the memory in a continuous manner at the time when writing the coded data has been completed.

14. A digital camera according to claim 13, wherein said processing unit includes:
a plurality of encoders which perform variable-length coding, in parallel, on the plurality of data blocks;
an address specifying unit which specifies, based on the amount of coded data generated by said encoders, a write-start address which is used when the coded data are written to the memory, for the plurality of data blocks; and
a write control unit which writes, in parallel, to the memory the coded data deriving from the plurality of data blocks, according to the write-start addresses specified for the plurality of data blocks.
